(19) United States
(12) Patent Application Publication
(10) Pub. No.: US 2007/0230811 A1
(43) Pub. Date: Oct. 4, 2007

(54) Method of enhancing entropy-coding efficiency, video encoder and video decoder thereof

(75) Inventor: Bae-keun Lee, Bucheon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/705,491

(22) Filed: Feb. 13, 2007

Related U.S. Application Data
(60) Provisional application No. 60/786,384, filed on Mar. 28, 2006.

(30) Foreign Application Priority Data
Jun. 27, 2006 (KR) 10-2006-0058216

(51) Int. Cl. G06K 9/36

(52) U.S. Cl. 382/244; 382/254

(57) ABSTRACT

A video encoder and encoding method are provided. The encoder includes a frame-encoding unit that generates at least one quality layer from an input video frame; a coding-pass-selection unit that selects a coding pass with reference to a second coefficient of a lower layer adjacent to a current layer included in the at least one quality layer, the second coefficient corresponding to a first coefficient of the current layer; and a pass-coding unit that encodes the first coefficient without loss according to the selected coding pass.

### CROSS-REFERENCE TO RELATED APPLICATIONS

This application is based on and claims priority from Korean Patent Application No. 10-2006-0058216 filed on Jun. 27, 2006, in the Korean Intellectual Property Office, and U.S. Provisional Patent Application No. 60/786,384 filed on Mar. 28, 2006 in the United States Patent and Trademark Office, the disclosures of which are incorporated herein in its entirety by reference.

### BACKGROUND OF THE INVENTION

1. Field of the Invention

Methods and apparatuses consistent with the present invention relate to a video-compression technology. More particularly, the present invention relates to a method and apparatus for enhancing encoding efficiency when entropy-encoding Fine Granular Scalability (FGS) layers.

2. Description of the Related Art

With the development of information and communication technologies, multimedia communications are increasing in addition to text and voice communications. The existing text-centered communication systems are insufficient to satisfy consumers' diverse desires, and thus multimedia services that can accommodate diverse forms of information such as text, images, music, and others, are increasing. Since multimedia data is large, mass storage media and wide bandwidths are required for storing and transmitting it. Accordingly, compression coding techniques are required to transmit multimedia data, which includes text, images and audio data.

The basic principle of data compression is to remove data redundancy. Data can be compressed by removing spatial redundancy such as the repetition of colors or objects in images, temporal redundancy such as little change in adjacent frames of a moving image or the continuous repetition of sounds in audio, and visual/perceptual redundancy, which considers human insensitivity to high frequencies. In a general video coding method, temporal redundancy is removed by temporal filtering based on motion compensation, and spatial redundancy is removed by a spatial transform.

After data is removed, the data is lossy encoded according to predetermined quantization steps through a quantization process. Finally, the data is losslessly encoded through entropy coding.

Currently, research on multilayer-based coding technology based on the H.264 standard is in progress in video-coding standardization performed by the Joint Video Team (JVT), a group of video professionals of the International Organization for Standardization/International Electrotechnical Commission (ISO/IEC), and the International Telecommunication Union (ITU). Particularly, the Fine Granular Scalability (FGS) technology has been adopted, which can improve the quality and bit rates of frames.

FIG. 1 illustrates the concept of a plurality of quality layers 11, 12, 13 and 14 that constitute one frame or slice 10 (Hereinafter, called a “slice”). A quality layer is data that has recorded one slice after partitioning the slice in order to support signal-to-noise ratio (SNR) scalability, and an FGS layer is a representative example, but the quality layer is not limited to this. A plurality of quality layers can consist of one base layer 14 and one or more FGS layers such as 11, 12 and 13 as illustrated in FIG. 1. The image quality measured in a video decoder is improved in the order of the case where only the base layer 14 is received, the case where the base layer 14 and the first FGS layer 13 are received, the case where the base layer 14, the first FGS layer 13, and the second FGS layer 12 are received, and the case where all layers 11, 12, 13 and 14 are received.

According to the Scalable Video Coding (SVC) draft, data is coded using the relation between FGS layers. In other words, other FGS layers are coded using the coefficient of one FGS layer according to a separated coding pass (a concept that includes a significant pass and a refinement pass). Here, in the case where all coefficients of the lower layer are zero, the coefficient of the current layer is coded by the significant pass, and in the case where there is at least one coefficient which is not zero, the coefficient of the current layer is coded by the refinement pass. Likewise, certain coefficients of FGS layers are coded by different passes because stochastic distribution of the coefficients are clearly distinguished depending on the coefficients of the lower layers.

FIG. 2A is a graph illustrating the zero probability of a coding pass when the coding pass of the first FGS layer has been selected with reference to the coefficient of the discrete layer. In FIG. 2A, SIG refers to a significant pass, and REF refers to a refinement pass. Referring to FIG. 2A, the probability distribution, in which zero is generated among coefficients of the first FGS layer coded by the significant pass because the coefficient corresponding to the discrete layer is zero, is different from the probability distribution, in which zero is generated among coefficients of the first FGS layer coded by the refinement pass because the coefficient pass corresponding to the discrete layer is not zero. Likewise, in the case where the zero-generated probability distribution is clearly distinguished, the coding efficiency can be improved by coding according to context models.

FIG. 2B is a graph illustrating the zero probability on a coding pass when coding the second FGS layer with reference to the coefficient of the discrete layer and the first FGS layer. Referring to FIG. 2B, the zero probabilities between the coefficient of the second FGS layer coded by the refinement pass and the coefficient of the second FGS layer coded by the significant pass are not separated but mixed. In other words, the coding method by passes disclosed in the SVC draft is efficient in coding the first FGS layer, but the efficiency may be lower when coding the second and other FGS layers. The efficiency can be reduced because there is a high stochastic relation between adjacent layers, but there is a low stochastic relation between non-adjacent layers.

### SUMMARY OF THE INVENTION

An aspect of the present invention provides a video encoder and method and a video decoder and method which may improve entropy coding and decoding efficiency of video data having a plurality of quality layers.

Another aspect of the present invention provides a video encoder and method and a video decoder and method which may reduce computational complexity in the entropy coding of video data having a plurality of quality layers.

According to an exemplary embodiment of the present invention, there is provided a video encoder including a frame-encoding unit that generates at least one quality layer from an input video frame; a coding-pass-selection unit that selects a coding pass with reference to a second coefficient of a lower layer adjacent to a current layer included in the at least one quality layer, the second coefficient corresponding to a first coefficient of the current layer; and a pass-coding unit that encodes the first coefficient without loss according to the selected coding pass.

According to an exemplary embodiment of the present invention, there is provided a video decoder including a coding-pass selection unit that selects a coding pass with reference to a second coefficient of a lower layer adjacent to a current layer, the second coefficient corresponding to a first coefficient of the current quality layer, wherein the current layer is one of at least one quality layer included in an input bit stream; a pass-decoding unit that decodes the first coefficient without loss according to the selected coding pass; and a frame-decoding unit that restores an image of the current layer from the first coefficient decoded without loss.

According to an exemplary embodiment of the present invention, there is provided a video-encoding method including generating at least one quality layer from an input video frame; selecting a coding pass with reference to a second coefficient of a lower layer adjacent to a current layer included in the at least one quality layer, the second coefficient corresponding to a first coefficient of the current layer; and encoding the first coefficient without loss according to the selected coding pass.

According to an exemplary embodiment of the present invention, there is provided a video-decoding method including selecting a coding pass with reference to a second coefficient of a lower layer adjacent to a current layer, the second coefficient corresponding to a first coefficient of the current quality layer, wherein the current layer is one of at least one quality layer included in an input bit stream; decoding the first coefficient without loss according to the selected coding pass; and restoring an image of the current layer from the decoded first coefficient.

### BRIEF DESCRIPTION OF THE DRAWINGS

The above and other aspects of the present invention will become apparent by describing in detail preferred embodiments thereof with reference to the attached drawings, in which:

FIG. 1 illustrates the concept of a plurality of quality layers that constitute one frame or slice.

FIG. 2A is a graph illustrating the zero probability of a coding pass when the coding pass of the first FGS layer has been selected with reference to the coefficient of the discrete layer.

FIG. 2B is a graph illustrating the zero probability of a coding pass when coding the second FGS layer with reference to the coefficient of the discrete layer and the first FGS layer.

FIG. 3 illustrates a process of expressing one slice as one base layer and two FGS layers.

FIG. 4 illustrates an example of arranging a plurality of quality layers in a bit stream.

FIG. 5 illustrates spatially-corresponding coefficients in a plurality of quality layers.

FIG. 6A illustrates a coding-pass-determination scheme in the scalable video coding (SVC) draft.

FIG. 6B illustrates a coding-pass-determination scheme according to an exemplary embodiment of the present invention.

FIG. 7A illustrates a zero probability according to a coding pass of a coefficient of a second FGS layer when encoding a Quarter Common Intermediate Format (QCIF) standard test sequence known as the FOOTBALL sequence by JSVM-5.

FIG. 7B illustrates a zero probability according to a coding pass of a coefficient of a second FGS layer when encoding the QCIF FOOTBALL sequence according to an exemplary embodiment of the present invention.

FIG. 8A illustrates an example of entropy coding coefficients through one loop in the order of scanning; and FIG. 8B illustrates an example of gathering coefficients by refinement passes and significant passes, and entropy-coding the coefficients.

FIG. 9 is a block diagram illustrating the structure of a video encoder according to an exemplary embodiment of the present invention.

FIG. 10 is a block diagram illustrating the detailed structure of a lossless encoding unit included in the video encoder of FIG. 9, according to an exemplary embodiment of the present invention.

FIG. 11 is a block diagram illustrating the structure of a video decoder according to an exemplary embodiment of the present invention.

FIG. 12 is a block diagram illustrating the detailed structure of a lossless decoding unit included in the video decoder of FIG. 11, according to an exemplary embodiment of the present invention.

FIG. 13 is an exemplary graph illustrating the comparison between peak signal-to-noise ratio (PSNR) of luminance elements when a related art technology is applied to a Common Intermediate Format (CIF) standard test sequence known as the BUS sequence, and PSNR of luminance elements when the present invention is applied to the CIF BUS sequence.

FIG. 14 is an exemplary graph illustrating the comparison between PSNR of luminance elements when the related art technology is applied to a four times CIF (4CIF) standard test sequence known as the HARBOUR sequence, and PSNR of luminance elements when the present invention is applied to the 4CIF HARBOUR sequence.

### DETAILED DESCRIPTION OF EXEMPLARY EMBODIMENTS

Exemplary embodiments of the present invention will be described in detail with reference to the accompanying drawings.

The present invention may be understood more readily by reference to the following detailed description of exemplary embodiments and the accompanying drawings. The present invention may, however, be embodied in many different forms and should not be construed as being limited to the exemplary embodiments set forth herein. Rather, these exemplary embodiments are provided so that this disclosure will be thorough and complete and will fully convey the concept of the invention to those skilled in the art, and the present invention will only be defined by the appended claims. Like reference numerals refer to like elements throughout the specification.

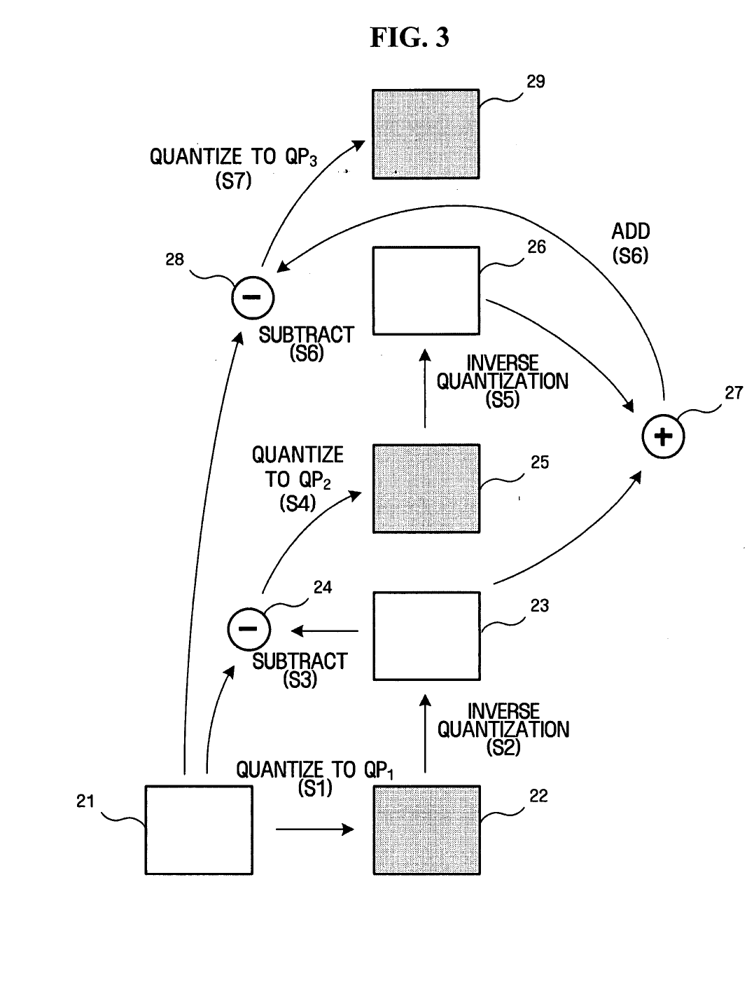

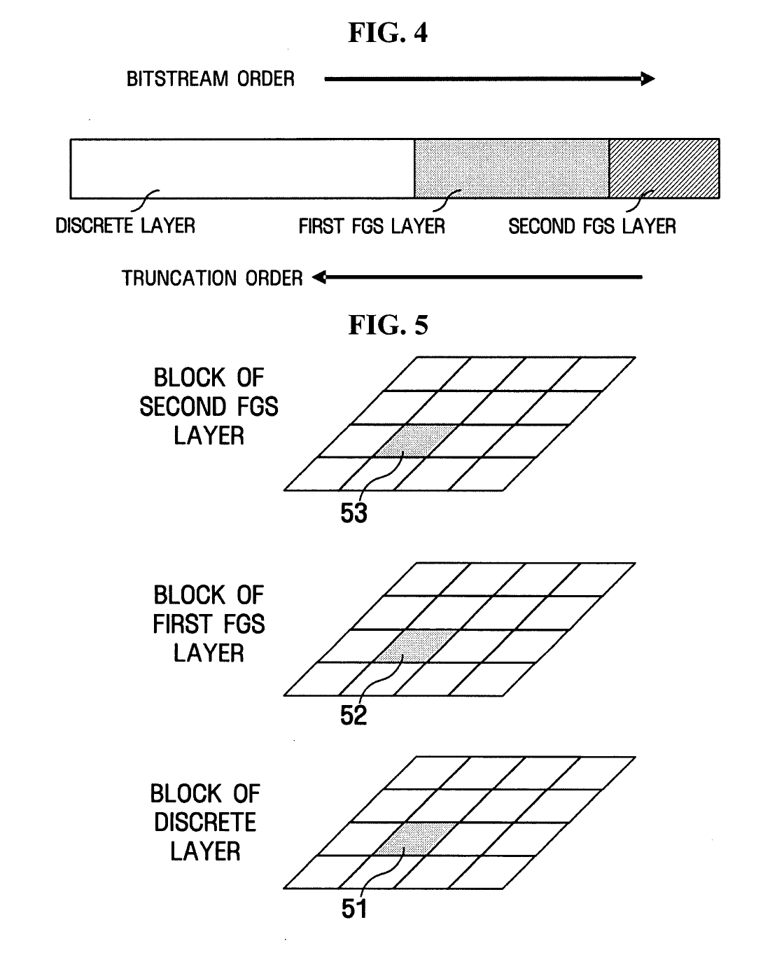

FIG. 3 illustrates a process of expressing one slice as one base layer and two FGS layers. An original slice is quantized by a first quantization parameter QP1 (S1). The quantized slice 22 forms a base layer. The quantized slice 22 is inverse-quantized (S2), and is then provided to a subtractor 24. The subtractor 24 subtracts the inverse-quantized slice 23 from the original slice (S3). The result of the subtraction is quantized using a second quantization parameter QP2 (S4). The result 25 of the quantization forms a first fine granular scalability (FGS) layer.

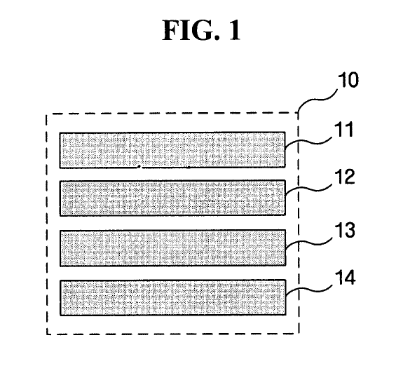

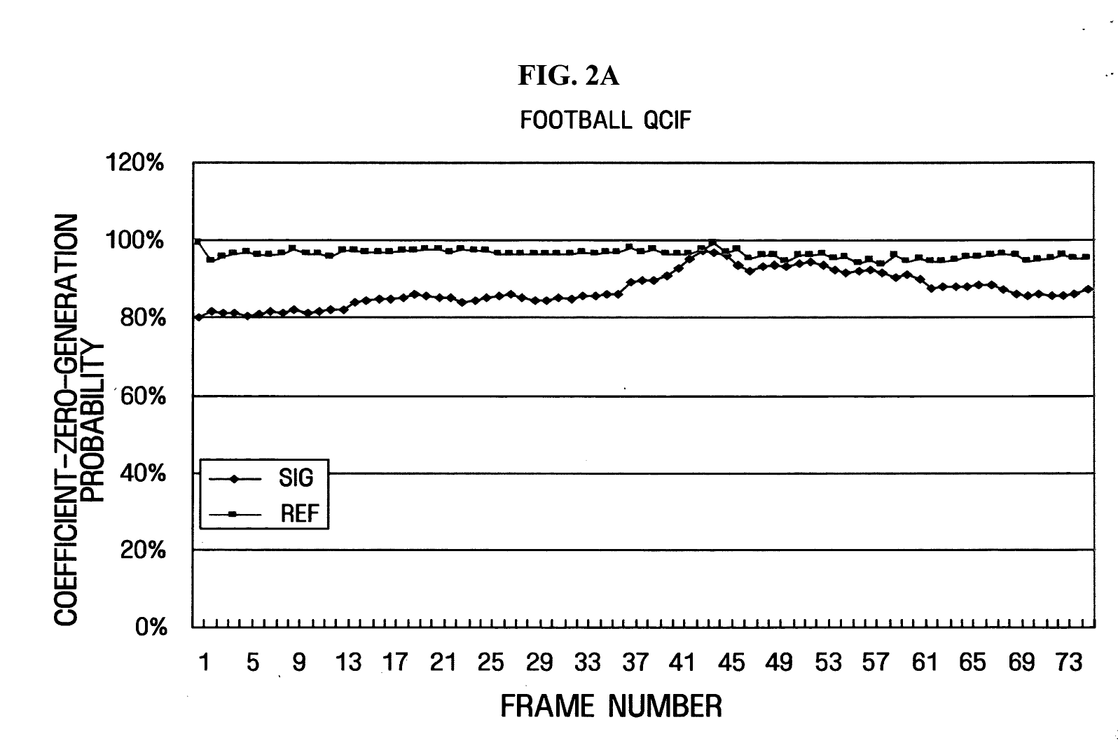

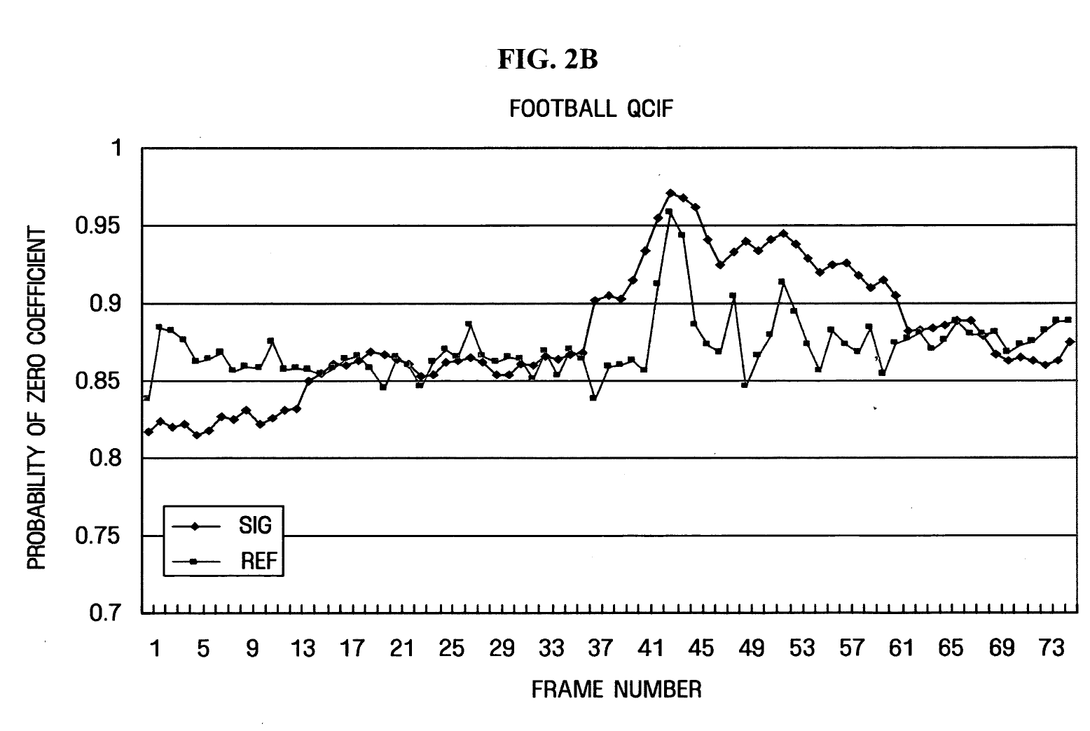

Next, the quantized slice 25 is inverse-quantized (S5), and is provided to an adder 27. The inverse-quantized slice 26 and the inverse-quantized slice 23 are added by the adder 27 (S6), and are then provided to a subtractor 28. The subtractor 28 subtracts the added result from the original slice (S7). The subtracted result is quantized by a third quantization parameter QP3 (S7). The quantized result 29 forms a second FGS layer. Through such a process, a plurality of quality layers can be produced, as illustrated in FIG. 1. Here, the first FGS layer and the second FGS layer are a structure that can truncate any arbitrary bit within one layer. For this, a bit-plane-coding technique, used in the existing MPEG-4 standard, a cyclic FGS-coding technique, used in the SVC draft, and others can be applied to each FGS layer.

As described above, coefficients corresponding to all layers are referred to when determining the coding pass of the coefficient of a certain FGS layer in the current SVC draft. Here, the “corresponding coefficient” refers to a coefficient in the same spatial position between a plurality of quality layers. For example, as illustrated in FIG. 5, if a 4×4 block is expressed as a discrete layer, a first layer, and a second layer, coefficients corresponding to a coefficient 53 of the second FGS layer are coefficient 52 of the first FGS layer and coefficient 51 of the discrete layer.

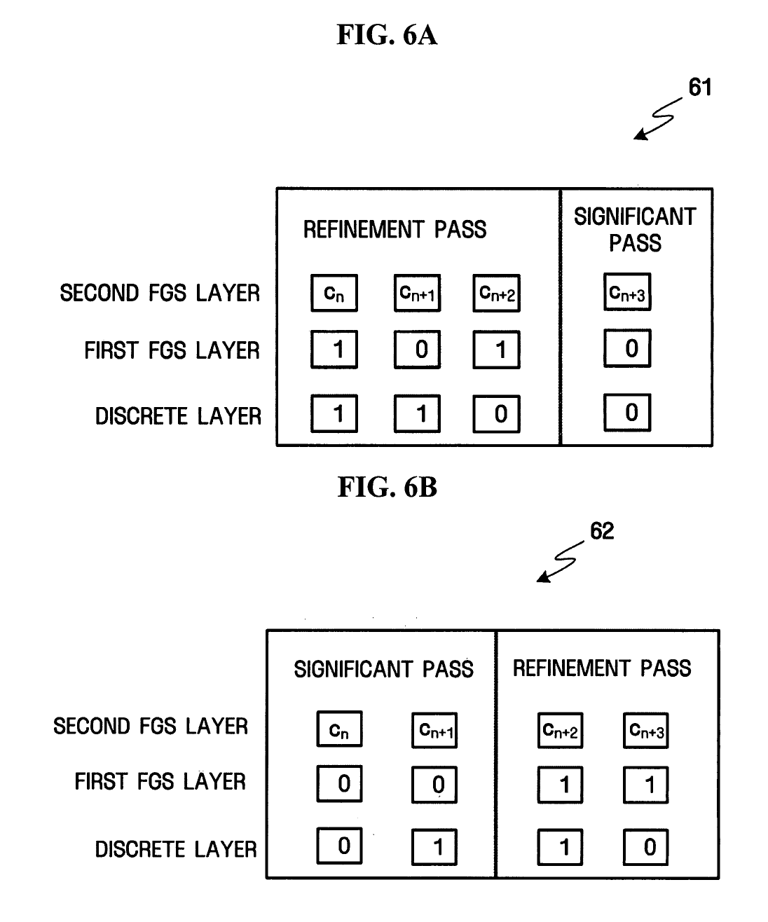

FIGS. 6A and 6B compare a coding-pass-determining scheme 61 in the SVC draft, and another coding-pass-determining scheme 62. In FIG. 6A, the coding pass of a coefficient of the second FGS layer is determined as the refinement pass if there is any non-zero value among coefficients of lower layers corresponding to the coefficient, otherwise, is determined as the significant pass. For example, in the case of cₙ, cₙ₊₁, and cₙ₊₂ among coefficients of the second FGS layer, because there is at least one non-zero coefficient in the lower layer, the coding pass is determined as the refinement pass, and in the case of cₙ₊₃, because all coefficients of the lower layer are zeros, the coding pass is determined as the significant pass.

In FIG. 6B, the coding pass of a coefficient of the second FGS layer is determined with reference to only the corresponding coefficient of the layer (an adjacent lower layer) just below the second FGS layer. Hence, if the corresponding coefficient of the first FGS layer, the adjacent lower layer, is zero, the coding pass is determined to be a significant pass, otherwise it is considered a refinement pass. The determination is made regardless of the coefficient of the discrete layer. Hence, cₙ and cₙ₊₁ are coded as a significant pass, and cₙ₊₂ and cₙ₊₃ are coded as a refinement pass.

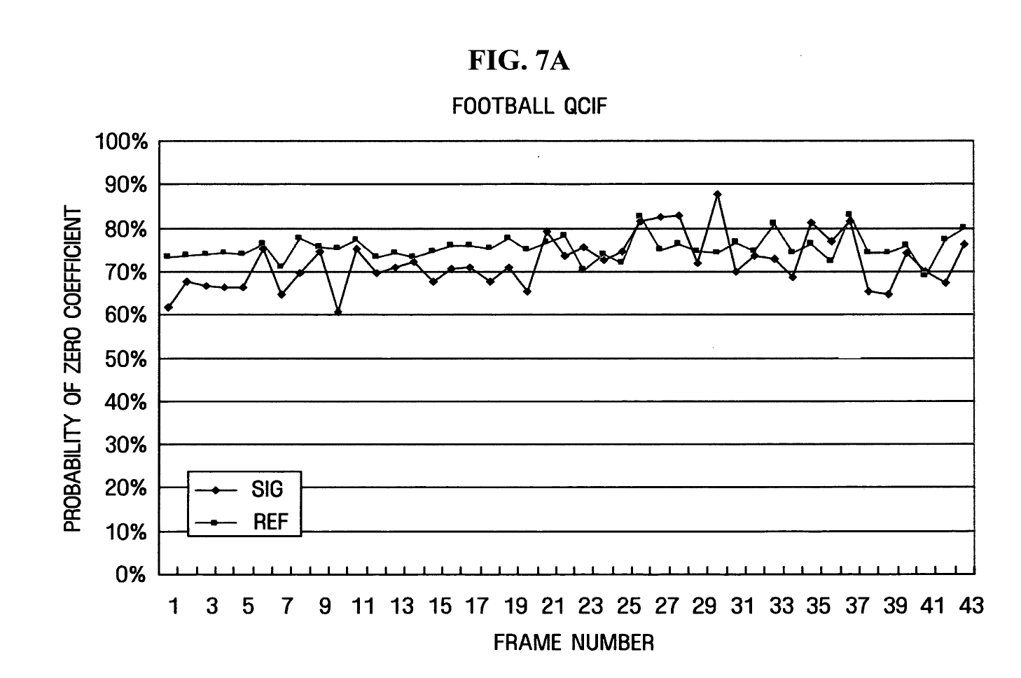

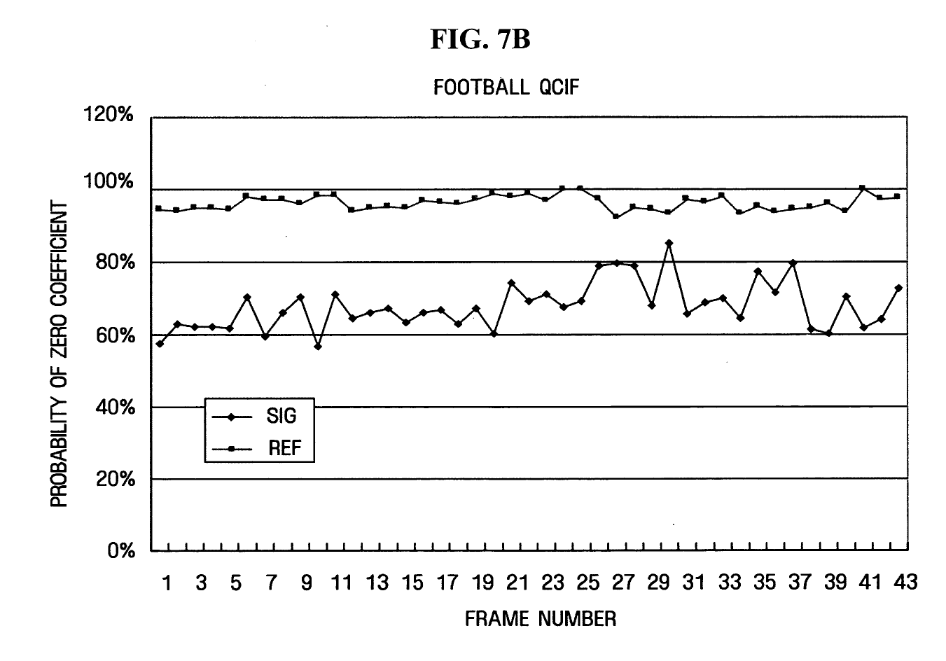

FIG. 7A illustrates a zero probability according to a coding pass of a coefficient of a second FGS layer when encoding a QCIF standard test sequence known as the FOOTBALL sequence in the H.264 related art by joint scalable video model (JSVM)-5. According to the SVC draft, the probability distributions by coding passes are not clearly distinguished, thus affecting the efficiency of the entropy coding.

FIG. 7B illustrates a zero probability according to a coding pass of a coefficient of a second FGS layer when encoding the QCIF FOOTBALL sequence according to an exemplary embodiment of the present invention. Referring to FIG. 7B, in the case of the refinement pass, the zero probability is almost 100%, and in the case of the significant pass, the zero probability is between 60 to 80%. Likewise, in the case where the coding pass is determined by referring to only the corresponding coefficient of an adjacent lower layer, there is a high possibility that the probability distributions are clearly distinguished by coding passes in the second FGS layer or other layers.

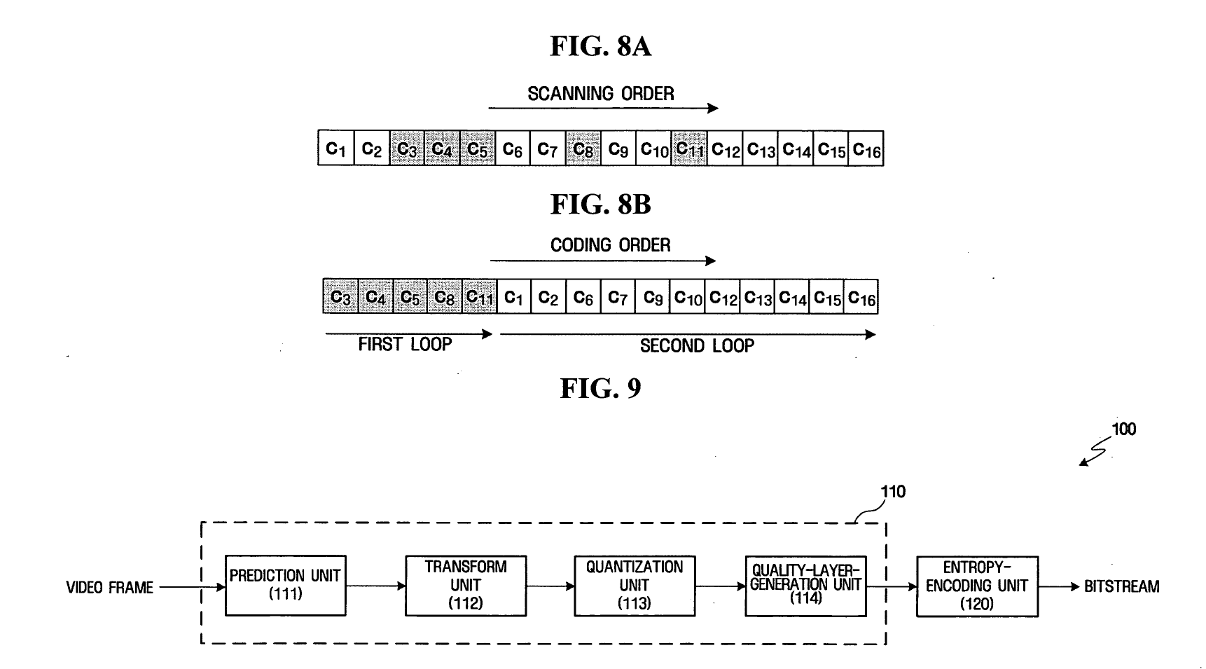

Further, according to the SVC draft, after the refinement pass and the significant pass are determined, as illustrated in FIG. 6A, coefficients corresponding to each coding pass are gathered, and are then entropy-coded. If the scanning order of 16 coefficients (c₁ to c₁₆) included in the 4×4 FGS layer block is determined, and among the coefficients, c₃, c₄, c₅, c₈, and c₁₁ are coefficients to be coded as the refinement pass, a total of two loops are needed, as illustrated in FIG. 8B. In the first loop, while retrieving 16 coefficients, only the coefficients corresponding to the refinement pass are entropy-coded, and in the second loop, while retrieving 16 coefficients, only the coefficients corresponding to the significant pass are entropy-coded. Likewise, such a two-pass algorithm can lower the operational speed of a video encoder or decoder.

Hence, according to an exemplary embodiment of the present invention, in order to reduce the number of operations, it is suggested that coefficients are not grouped by coding passes as in the SVC draft, and the entropy coding is performed through one loop in the order of scanning as illustrated in FIG. 8A. In other words, the coefficients are entropy-coded in the scanning order regardless of whether a certain coefficient is a refinement pass or a significant pass.

Table 1 is an example of a pseudo-code illustrating a process included in JSVM-5, and Table 2 is an example of a pseudo-code illustrating a process according to an exemplary embodiment of the present invention.

TABLE 1
Process According to JSVM-5

```
while (iLumaScanIdx < 16 || iChromaDCScanIdx < 4 || iChromaACScanIdx < 16) {
    for ( UInt uiMbYIdx = uiFirstMbY; uiMbYIdx < uiLastMbY; uiMbYIdx++ )
    for( UInt uiMbXIdx = uiFirstMbX ; uiMbXIdx < uiLastMbY; uiMbXIdx++ ) {
      for( UInt uiB8YIdx = 2 * uiMbYIdx; uiB8YIdx < 2 * uiMbYIdx + 2; uiB8YIdx++ )
      for( UInt uiB8XIdx = 2 * uiMbXIdx; uiB8XIdx < 2 * uiMbXIdx + 2; uiB8XIdx++ ) {
        for( UInt uiBlockYIdx = 2 * uiB8YIdx; uiBlockYIdx < 2 * uiB8YIdx + 2;
uiBlockYIdx++ )
        for( UInt uiBlockXIdx = 2 * uiB8XIdx; uiBlockXIdx < 2 * uiB8XIdx + 2;
uiBlockXIdx++ ) {
          if (iLumaScanIdx < 16) {
            UInt uiBlockIndex = uiBlockYIdx * 4 * m_uiWidthInMB + uiBlockXIdx;
            if(m_apaucBQLumaCoefMap[iLumaScanIdx][uiBlockIndex] & SIGNIFICANT) {
            xEncodeCoefficientLumaRef( uiBlockYIdx, uiBlockXIdx, iLumaScanIdx) );
            }
          }
        }
      }
  }
}
while (iLumaScanIdx < 16 || iChromaDCScanIdx < 4 || iChromaACScanIdx < 16) {
  for ( UInt uiMbYIdx = uiFirstMbY; uiMbYIdx < uiLastMbY; uiMbYIdx++ )
  for( UInt uiMbXIdx = uiFirstMbX ; uiMbXIdx < uiLastMbY; uiMbXIdx++ ) {
    for( UInt uiB8YIdx = 2 * uiMbYIdx; uiB8YIdx < 2 * uiMbYIdx + 2; uiB8YIdx++ )
    for( UInt uiB8XIdx = 2 * uiMbXIdx; uiB8XIdx < 2 * uiMbXIdx + 2; uiB8XIdx++ ) {
        for( UInt uiBlockYIdx = 2 * uiB8YIdx; uiBlockYIdx < 2 * uiB8YIdx + 2;
uiBlockYIdx++ )
        for( UInt uiBlockXIdx = 2 * uiB8XIdx; uiBlockXIdx < 2 * uiB8XIdx + 2;
uiBlockXIdx++ ) {
          if (iLumaScanIdx < 16) {
        xEncodeCoefficientLuma( uiBlockYIdx, uiBlockXIdx, iLumaScanIdx) );
          }
        }
      }
    }
  }
```

TABLE 2
Process According to the Present Invention.

```
while (iLumaScanIdx < 16 || iChromaDCScanIdx < 4 || iChromaACScanIdx < 16) {
  for ( UInt uiMbYIdx = uiFirstMbY; uiMbYIdx < uiLastMbY; uiMbYIdx++ )
  for( UInt uiMbXIdx = uiFirstMbX ; uiMbXIdx < uiLastMbY; uiMbXIdx++ ) {
    for( UInt uiB8YIdx = 2 * uiMbYIdx; uiB8YIdx < 2 * uiMbYIdx + 2; uiB8YIdx++ )
    for( UInt uiB8XIdx = 2 * uiMbXIdx; uiB8XIdx < 2 * uiMbXIdx + 2; uiB8XIdx++ ) {
        for( UInt uiBlockYIdx = 2 * uiB8YIdx; uiBlockYIdx < 2 * uiB8YIdx + 2;
uiBlockYIdx++ )
        for( UInt uiBlockXIdx = 2 * uiB8XIdx; uiBlockXIdx < 2 * uiB8XIdx + 2;
uiBlockXIdx++ ) {
            if (iLumaScanIdx < 16) {
          xEncodeCoefficientLuma( uiBlockYIdx, uiBlockXIdx, iLumaScanIdx) );
          }
        }
      }
    }
```

The code of Table 2 is significantly shorter than the code of Table 1. Further, a “while” loop is used two times in Table 1, but only one “while” loop is used in Table 2. Hence, it is clear that the number of operations will be reduced by using the algorithm in Table 2.

FIG. 9 is a block diagram illustrating the structure of a video encoder according to an exemplary embodiment of the present invention. A video encoder 100 can include a frame-encoding unit 110 and an entropy-encoding unit 120.

The frame-encoding unit 110 generates at least one quality layer from an input video frame.

For this, the frame-encoding unit 110 can include a prediction unit 111, a transform unit 112, a quantization unit 113, and a quality-layer-generation unit 114.

The prediction unit 111 acquires a residual signal by differentiating a predicted image according to a predetermined prediction method in a current macroblock. Some examples of the prediction method are prediction techniques disclosed in the SVC draft, i.e., an inter-prediction, a directional-intra-prediction, and an intra-base-layer (intra-BL) prediction. The inter-prediction can include a motion-estimation process that acquires a motion vector to express a relative movement between a frame having the same resolution and a different temporal position than the current frame, and the current frame. Further, the current frame is positioned at the same temporal location as a corresponding frame in a lower layer, and can be predicted with reference to the corresponding frame of the lower layer (the base layer) that has the different resolution from the current frame, which is called an intra-base-layer prediction. The motion-estimation process is not necessary in the intra-base-layer prediction.

The transform unit 112 transforms the acquired residual signal using a spatial transform technique such as discrete cosine transform (DCT) or wavelet transform, and generates the transform coefficient. As a result, a transform coefficient is generated. In the case where DCT is used, a DCT coefficient is generated, and in the case where wavelet transform is used, a wavelet coefficient is generated.

The quantization unit 113 generates a quantization coefficient by quantizing a transform coefficient generated in the spatial transform unit 112. A quantization refers to dividing the transform coefficient expressed as a real number into certain sections, and indicating the transform coefficient by a discrete value. Some examples of such a quantization method are a scalar quantization and a vector quantization.

The quality-layer-generation unit 114 generates a plurality of quality layers through a process illustrated in FIG. 3. The plurality of quality layers can consist of one discrete layer and one or more FGS layers. The discrete layer is independently encoded and decoded, but the FGS layer is encoded and decoded with reference to other layers.

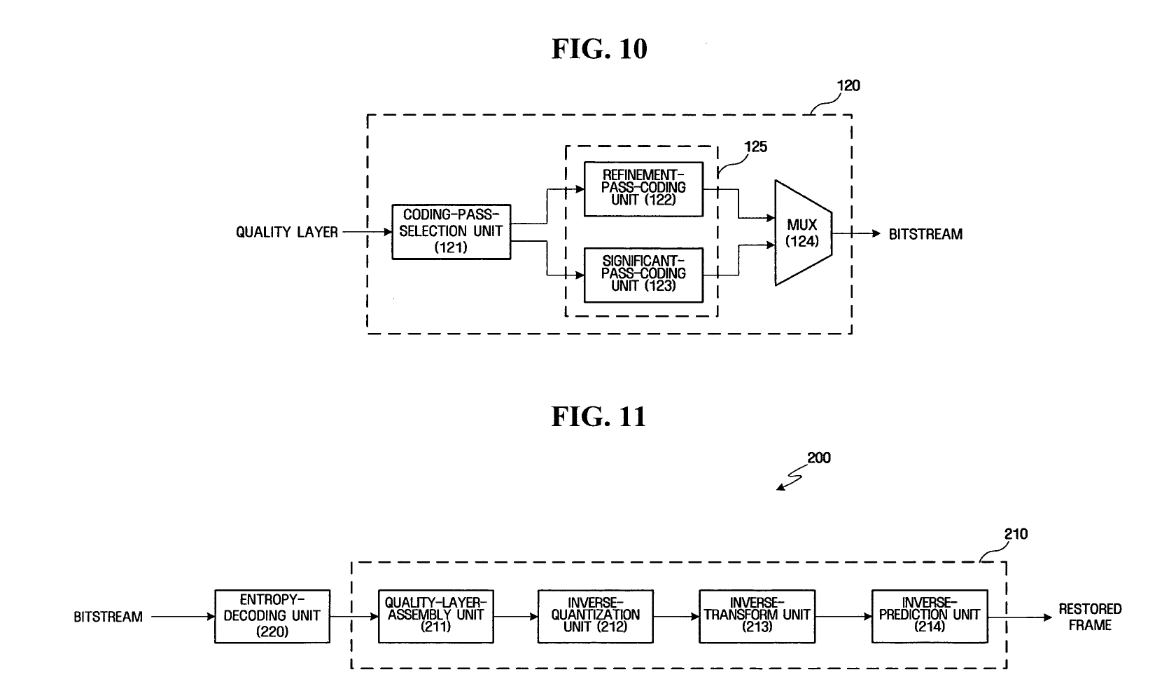

The entropy-encoding unit 120 performs an independent encoding without loss. The detailed structure of the lossless encoding unit 120 is illustrated in FIG. 10 according to an exemplary embodiment of the present invention. Referring to FIG. 10, the entropy-encoding unit 120 can include a coding-pass-selection unit 121, a refinement-pass-coding unit 122, a significant-pass-coding unit 123, and a multiplexer (MUX) 124.

The coding-pass-selection unit 121 refers to only a block of the adjacent lower layer of the quality layer in order to code the coefficient of the current block (a 4×4 block, an 8×8 block, or a 16×16 block) that belongs to the quality layer. In the present invention, preferably but not necessarily, the quality layer is the second or higher layer. The coding-pass-selection unit 121 determines whether the coefficient spatially corresponding to the coefficient of the current block is zero among coefficients of the referred blocks. In the case where the corresponding coefficient is zero, the coding-pass-selection unit 121 selects the significant pass as the coding pass on the coefficient of the current block, and in the case where the corresponding coefficient is not zero, the coding-pass-selection unit 121 selects the refinement pass as the coding pass.

A pass-coding unit 125 encodes the coefficient of the current block without loss (entropy encoding). For this, the pass-coding unit 125 includes the refinement-pass-coding unit that encodes the coefficient of the current block according to the refinement pass, and the significant-pass-coding unit 123 that encodes the coefficient of the current block according to the significant pass. A method used in the SVC draft can be used as a specific method that performs an entropy-coding according to an actual real pass or a significant pass. Further, JVT-P056, a SVC suggestion document, suggests a coding technique on the significant pass, which is described in the following. The codeword, the result of the encoding, is featured by a cut-off parameter “m”. If “C” to be coded is the same as or smaller than “m”, the symbol is encoded using Exp_Golomb code. If “C” is larger than “m”, the symbol is divided into two parts, the length and the suffix according to the following Equation 1, and is then encoded.

$$P = ⌊ \frac{C - m}{3} ⌋ + m \qquad ( 1 )$$

The P is the encoded codeword, and includes a length and a suffix (00, 01, or 10).

Further, since there is a high possibility that zero is generated in the refinement pass, JVT-P056 suggests a context-adaptive variable length coding (CAVLC) technique that allocates codewords having different lengths. The refinement-coefficient group refers to a group that has collected refinement coefficients by a predetermined number of units, e.g., four refinement coefficients can be regarded as one refinement coefficient group.

It is possible that the refinement pass is coded using a context-adaptive binary arithmetic coding (CABAC) technique. CABAC is a method that selects a probability model on a predetermined coding object, and performs an arithmetic coding. Generally, the CABAC process includes a binary coding, a context-model selection, an arithmetic coding, and a probability update.

The pass-coding unit 125 can entropy-code the coefficient of the quality layer using a single loop within a predetermined block unit (4×4, 8×8, or 16×16). In other words, as in the SVC draft, the coefficient selected as a refinement pass and the coefficient selected as a significant pass are not separately gathered for coding, but the refinement-pass coding or the significant-pass coding are performed in the scanning order of the coefficient.

The MUX 124 multiplexes the output of the refinement-pass-coding unit 122 and the output of the significant-pass-coding unit 123, and outputs the multiplexed outputs as one bit stream.

FIG. 11 is a block diagram illustrating the structure of a video decoder 200 according to an exemplary embodiment of the present invention. The video decoder 200 includes an entropy-decoding unit 220 and a frame-decoding unit 210.

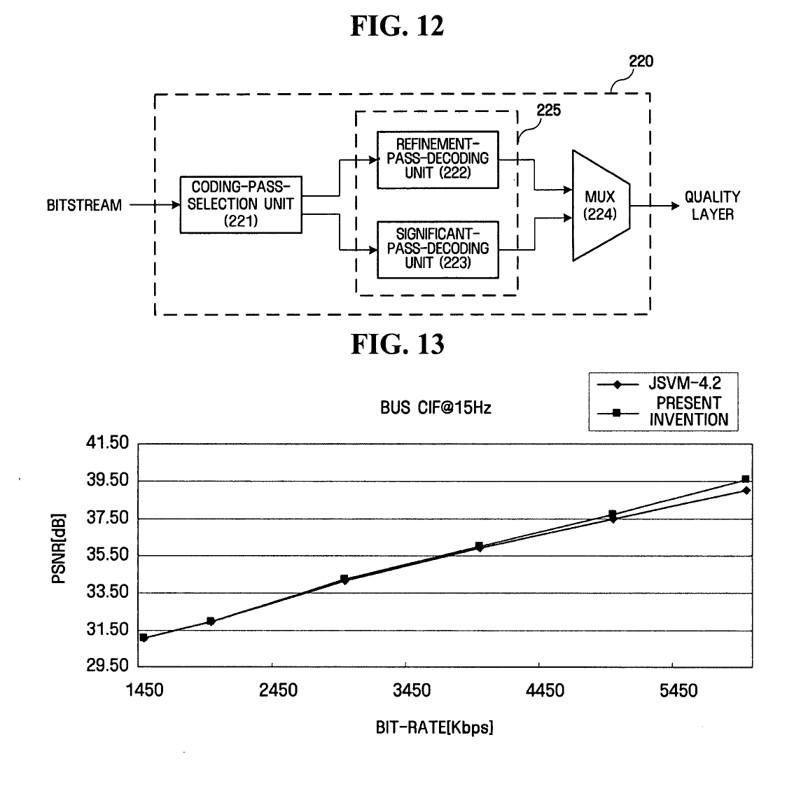

The entropy-decoding unit 220 performs an entropy-decoding of the coefficient of the current block that belongs to at least one quality layer included in an input bit stream according to an exemplary embodiment of the present invention. The entropy-decoding unit 220 will be described in detail with reference to FIG. 12 according to an exemplary embodiment of the present invention.

The frame-decoding unit 210 restores the image of the current block from the coefficient of the current block decoded without loss by the entropy-decoding unit 220. For this, the frame-decoding unit 210 includes a quality-layer-assembly unit 211, an inverse-quantization unit 212, an inverse-transform unit 213, and an inverse-prediction unit 214.

The quality-layer-assembly unit 211 generates one set of slice data or frame data by adding a plurality of quality layers, as illustrated in FIG. 1.

The inverse-quantization unit 212 inverse-quantizes data provided by the quality-layer-assembly unit 211.

The inverse-transform unit 213 performs the inverse transform on the result of the inverse quantization. Such an inverse transform inversely performs the transform process performed in the transform unit 112 of FIG. 10.

The inverse-prediction unit 214 restores a video frame by adding the prediction signal to the restored residual signal provided by the inverse-transform unit 213. Here, the prediction signal can be acquired by the inter-prediction or the intra-base-layer prediction as in the video encoder.

FIG. 12 is a block diagram illustrating the detailed structure of an entropy-decoding unit 220. The entropy-decoding unit 220 can include a coding-pass-selection unit 221, a refinement-pass-decoding unit 222, a significant-pass-decoding unit 223, and a MUX 224.

The coding-pass-selection unit 221 refers to a block of an adjacent-lower layer of the quality layer in order to code the coefficient of the current block (4×4, 8×8, or 16×16) that belongs to at least one quality layer included in the input bit stream. The coding-pass-selection unit 221 determines whether the coefficient spatially corresponding to the coefficient of the current block is zero. In the case where the corresponding coefficient is zero, the coding-pass-selection unit 221 selects the significant pass as the coding pass on the coefficient of the current block, and in the case where the corresponding coefficient is not zero, the coding-pass-selection unit 221 selects the refinement pass as the coding pass.

The pass-decoding unit 225 losslessly decodes the coefficient of the current block according to the selected coding pass. For this, the pass-decoding unit 225 includes the refinement-pass-decoding unit 222 that decodes the coefficient of the current block according to the refinement pass in the case where the corresponding coefficient is not zero (1 or larger), and the significant-pass-decoding unit 225 that decodes the coefficient of the current block according to the significant pass in the case where the corresponding coefficient is zero. Like the pass-coding unit 125, the pass-decoding unit 225 can perform the lossless decoding of the coefficient using a single loop.

The MUX 224 generates data (a slice or a frame) about one quality layer by multiplexing the output of the refinement-pass-decoding unit 222, and the output of the significant-pass-decoding unit 223.

Each element in FIGS. 9 to 12 can be implemented as a software component such as a task, a class, a subroutine, a process, an object, or a program, or a hardware component such as a Field Programmable Gate Array (FPGA) or an Application Specific Integrated Circuit (ASIC), which performs certain tasks, or as a combination of such software or hardware components. The components can be stored in a storage medium, or can be distributed partially in a plurality of computers.

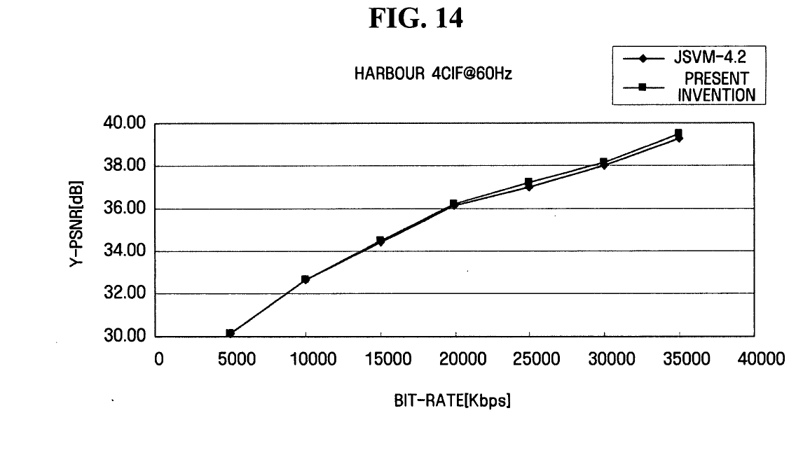

FIG. 13 is an exemplary graph illustrating the comparison between PSNR of luminance elements when a related art technology is applied on a CIF standard test sequence known as the BUS sequence in the H.264 related art, and PSNR of luminance elements when the present invention is applied on the CIF BUS sequence, and FIG. 14 is a exemplary graph illustrating the comparison between PSNR of luminance elements when the conventional technology is applied to a 4CIF standard test sequence known as the HARBOUR sequence in the H.264 related art, and the PSNR of luminance elements when the present invention is applied to the 4CIF HARBOUR sequence. Referring to FIGS. 13 and 14, as the bit rate increases, the effect by the application of the present invention becomes clearer. The effect may be different depending on the video sequence, but the improvement of the PSNR by the application of the present invention is between 0.25 dB and 0.5 dB.

It should be understood by those of ordinary skill in the art that various replacements, modifications and changes may be made in the form and details without departing from the spirit and scope of the present invention as defined by the following claims. Therefore, it is to be appreciated that the above described exemplary embodiments are for purposes of illustration only and are not to be construed as limitations of the invention.

The method and apparatus of the present invention has the following advantages.

First, an entropy-coding efficiency of video data having a plurality of quality layers is improved.

Second, the computational complexity of entropy-coding of video data having a plurality of quality layers is reduced.

What is claimed is:

1. A video encoder comprising:
a frame-encoding unit that generates at least one quality layer from an input video frame;
a coding-pass-selection unit that selects a coding pass with reference to a second coefficient of a lower layer adjacent to a current layer included in the at least one quality layer, the second coefficient corresponding to a first coefficient of the current layer; and
a pass-coding unit that encodes the first coefficient without loss according to the selected coding pass.

2. The encoder of claim 1, wherein the at least one quality layer comprises one discrete layer and at least one FGS layer.

3. The encoder of claim 2, wherein, if the at least one quality layer comprises two or more FGS layers, the current layer is a higher FGS layer.

4. The encoder of claim 1, wherein the pass-coding unit comprises:
a refinement-pass-coding unit that encodes the first coefficient without loss according to a refinement pass if the second coefficient is not zero; and
a significant-pass-coding unit that encodes the first coefficient without loss according to a significant pass if the second coefficient is zero.

5. The encoder of claim 1, wherein the pass-coding unit encodes the first coefficient without loss using a single loop within a block unit of the current layer.

6. The encoder of claim 5, wherein the block unit is a unit of a 4×4 block, an 8×8 block, or a 16×16 block.

7. A video decoder comprising:
a coding-pass selection unit that selects a coding pass with reference to a second coefficient of a lower layer adjacent to a current layer, the second coefficient corresponding to a first coefficient of the current quality layer, wherein the current layer is one of at least one quality layer included in an input bit stream;
a pass-decoding unit that decodes the first coefficient without loss according to the selected coding pass; and
a frame-decoding unit that restores an image of the current layer from the first coefficient decoded without loss.

8. The decoder of claim 7, wherein the at least one quality layer comprises one discrete layer and at least one FGS layer.

9. The decoder of claim 8, wherein, if the at least one quality layer comprises two or more FGS layers, the current layer is a higher FGS layer.

10. The decoder of claim 7, wherein the pass-decoding unit comprises:
a refinement-pass-decoding unit that decodes the first coefficient without loss according to a refinement pass if the second coefficient is not zero; and
a significant-pass-decoding unit that decodes the first coefficient without loss according to a significant pass if the second coefficient is zero.

11. The decoder of claim 7, wherein the pass-decoding unit decodes the first coefficient without loss using a single loop within a block unit of the current layer.

12. The decoder of claim 11, wherein the block unit is a unit of a 4×4 block, an 8×8 block, or a 16×16 block.

13. A video-encoding method comprising:
generating at least one quality layer from an input video frame;
selecting a coding pass with reference to a second coefficient of a lower layer adjacent to a current layer included in the at least one quality layer, the second coefficient corresponding to a first coefficient of the current layer; and
encoding the first coefficient without loss according to the selected coding pass.

14. The video-encoding method of claim 13, wherein the at least one quality layer comprises one discrete layer and at least one FGS layer.

15. The video-encoding method of claim 14, wherein, if the at least one quality layer comprises two or more FGS layers, the current quality layer is a second FGS layer or a higher FGS layer.

16. The video-encoding method of claim 13, wherein the encoding of the first coefficient comprises:
encoding the first coefficient without loss according to a refinement pass if the second coefficient is not zero; and
encoding the first coefficient without loss according to a significant pass if the second coefficient is zero.

17. The video-encoding method of claim 13, wherein the encoding of the first coefficient without loss is performed using a single loop within a block unit of the current layer.

18. The video-encoding method of claim 13, wherein the block unit is a unit of a 4×4 block, an 8×8 block, or a 16×16 block.

19. A video-decoding method comprising:
selecting a coding pass with reference to a second coefficient of a lower layer adjacent to a current layer, the second coefficient corresponding to a first coefficient of the current quality layer, wherein the current layer is one of at least one quality layer included in an input bit stream;
decoding the first coefficient without loss according to the selected coding pass; and
restoring an image of the current layer from the decoded first coefficient.

20. The video-decoding method of claim 18, wherein the at least one quality layer comprises one discrete layer and at least one FGS layer.

21. The video-decoding method of claim 19, wherein, if the at least one quality layer comprises two or more FGS layers, the current quality layer is a second FGS layer or a higher FGS layer.

22. The video-decoding method of claim 18, the decoding of the first coefficient comprises:
decoding the first coefficient without loss according to a refinement pass if the second coefficient is not zero; and
decoding the first coefficient without loss according to a significant pass if the second coefficient is zero.

23. The video-decoding method of claim 18, wherein the decoding of the first coefficient is performed using a single loop within a block unit of the current layer.

24. The video-decoding method of claim 18, wherein the block unit is a unit of a 4×4 block, an 8×8 block, or a 16×16 block.
